(19) United States
(12) Patent Application Publication
(10) Pub. No.: US 2014/0176847 A1
(43) Pub. Date: Jun. 26, 2014

(54) DISPLAY DEVICE AND METHOD OF MANUFACTURING THE SAME

(71) Applicant: SAMSUNG DISPLAY CO., LTD., Yongin-City (KR)

(72) Inventors: Woo Yong SUNG, Seoul (KR); Jeong Ho LEE, Seoul (KR); Cha-Dong KIM, Seoul (KR); Tae Woon CHA, Seoul (KR)

(73) Assignee: Samsung Display Co., Ltd., Yongin-City (KR)

(21) Appl. No.: 13/856,713

(22) Filed: Apr. 4, 2013

(30) Foreign Application Priority Data
Dec. 21, 2012 (KR) 10-2012-0151132

(51) Int. Cl. G02F 1/1337

(52) U.S. Cl. CPC G02F 1/13378
USPC 349/58; 427/162; 156/60

(57) ABSTRACT

A method of manufacturing a display device includes: providing an outline frame on a first substrate; and providing a thin film by dropping a thin film material inside a boundary defined by the outline frame. The outline frame limits a boundary of the thin film, and the frame material of the outline frame includes a material having a surface energy that is less than a surface energy of the thin film material of the thin film.

This application claims priority to Korean Patent Application No. 10-2012-0151132 filed on Dec. 21, 2012, and all the benefits accruing therefrom under 35 U.S.C. §119, the entire contents of which are incorporated herein by reference.

### BACKGROUND

(a) Field

The invention relates to a display device, and a method of manufacturing the same, and more particularly, to a display device including a thin film formable by using an inkjet printing method, and a method of manufacturing the same.

(b) Description of the Related Art

A flat panel display refers to a display device having a smaller cross-sectional thickness compared to a planar size of a screen thereof. The flat panel display includes a liquid crystal display, an organic light emitting diode display, an electrophoretic display, an electrowetting display and the like.

The liquid crystal display, which is an example of the flat panel display device, includes two display panels in which electric field generating electrodes, such as a pixel electrode and a common electrode, and an alignment film are formed. The liquid crystal display further includes a liquid crystal layer interposed between the two display panels, and a plurality of color filters for displaying colors. The alignment film determines an initial alignment of liquid crystal molecules of the liquid crystal layer, and the electric field generating electrodes generate an electric field which changes alignment of the liquid crystal molecules of the liquid crystal layer. In the liquid crystal display, a polarization state of incident light passing through the liquid crystal layer is changed according to the alignment of the liquid crystal molecules. The change in polarization is represented with a change in transmittance of light by a polarizer.

The organic light emitting diode display, which is another example of the flat panel display device, includes two electrodes such as a pixel electrode and a common electrode, and a light emitting layer interposed therebetween. Electrons injected from one electrode and holes injected from the other electrode are combined in a light emitting layer of the organic light emitting diode display to form excitons, and the excitons emit light while discharging energy.

The flat panel display device further includes a switching element connected to the pixel electrode, and a plurality of signal lines such as gate lines and data lines for controlling the switching element and applying a voltage to the pixel electrode.

### SUMMARY

One or more exemplary embodiment of the invention reduces or effectively removes non-uniformity of a boundary line of a thin film by increasing or limiting a position and a shape of the boundary of the thin film formed by an inkjet printing method.

Further, one or more exemplary embodiment of the invention decreases a width of a boundary portion of a liquid crystal display by increasing or limiting a position and a shape of an alignment layer formed by an inkjet printing method.

An exemplary embodiment of the invention provides a method of manufacturing a display device, including: providing an outline frame on a first substrate; and providing a thin film by dropping a thin film material inside a boundary defined by the outline frame. The outline frame limits a boundary of the thin film, and the frame material of the outline frame includes a material having a surface energy that is less than a surface energy of the thin film material of the thin film.

The providing the outline frame may include continuously dropping the frame material on the first substrate using a continuous jet printing method.

The outline frame may include multiple lines spaced apart from each other.

The frame material of the outline frame may include a hydrophobic material.

The outline frame may include a closed curved line.

The thin film may include an alignment layer, and the alignment layer may include an alignment solution.

The frame material of the outline frame may include the alignment solution.

A viscosity of the alignment solution of the outline frame may be higher than a viscosity of the alignment solution of the alignment layer.

The method may further include: preparing a second substrate and disposing the second substrate facing the first substrate; and providing a sealant between the first substrate and the second substrate. The first substrate and the second substrate include a display area in which an image is displayed, and a peripheral area around the display area. The outline frame is between the sealant and the display area.

A width of the outline frame may be about 10 micrometers (μm) to about 100 μm.

A distance between the outline frame and the display area may be equal to or smaller than about 100 μm.

Another exemplary embodiment of the invention provides a display device formed by the above-described method. The display device includes: a first substrate; and a thin film on the first substrate, and provided by dropping an ink on the first substrate using an inkjet printing method. The outline frame is provided before the thin film is provided, along a boundary of an area of the first substrate in which the thin film is to be provided. The outline frame defines and limits the boundary of the thin film, and the outline frame includes a material having a surface energy less than a surface energy of the thin film material of the thin film.

A boundary of the outline frame may be substantially even and continuous.

The outline frame may include multiple lines spaced apart from each other.

The outline frame may include a closed curved line.

The thin film may include an alignment layer, and the alignment layer may include an alignment solution.

The alignment solution may include an alignment layer material, and the frame material of the outline frame may include the alignment layer material.

The display device may further include: a second substrate facing the first substrate; and a sealant between the first substrate and the second substrate. The first substrate and the second substrate may include a display area in which an image is displayed, and a peripheral area around the display area. The outline frame is between the sealant and the display area.

A width of the outline frame may be about 10 μm to about 100 μm.

A distance between the outline frame and the display area may be equal to or smaller than about 100 μm.

According to one or more exemplary embodiment of the invention, non-uniformity of a boundary line of a thin film is reduced or effectively removed by increasing or limiting a control force for a position and a shape of the boundary of the thin film formed by an inkjet printing method. Further, according to one or more exemplary embodiment of the invention, a width of a peripheral area of a liquid crystal display is decreased by increasing or limiting a control force for a position and a shape of the boundary of the alignment layer formed by an inkjet printing method.

### BRIEF DESCRIPTION OF THE DRAWINGS

The above and other features of this disclosure will become more apparent by describing in further detail exemplary embodiments thereof with reference to the accompanying drawings, in which:

FIG. 1 is a top plan view of an exemplary embodiment of a display device according to the invention.

FIG. 2 is a cross-sectional view taken along line II-II of the display device of FIG. 1.

FIGS. 3 and 4 are top plan views of alternative exemplary embodiments of a display device according to the invention, respectively.

FIGS. 5 and 6 are cross-sectional views illustrating an exemplary embodiment of a method of manufacturing a display device according to the invention, respectively.

FIG. 7 is a cross-sectional view of an exemplary embodiment of a peripheral area of a display panel of a display device according to the invention.

### DETAILED DESCRIPTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” relative to other elements or features would then be oriented “above” relative to the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Various flat panel display devices include various electrical elements, wirings, electrodes and the like. The various electrical elements are generally formed by using a photolithography process. In the photolithography process, a to-be-etched layer is applied on a substrate, a photoresist layer (referred to as a photosensitive film) is applied on the to-be-etched layer, and then a mask for exposing the layered structure is positioned to perform exposure of the layered structure. Further in the photolithography process, a photosensitive pattern is formed by developing the exposed photosensitive film. A pattern of a target electrode, wiring and the like, is formed by etching the to-be-etched layer by using the photosensitive pattern as an etching mask.

A line width of a manufactured pattern is limited due to a limitation in resolution of an exposer used in the photolithography process, such that a new and high-priced exposing device, process, material and the like has been investigated in order to overcome the limitation of the resolution. Further, as a planar size of the flat panel display device becomes relative large, a quantity of material, such as the photosensitive film, which is applied on a substrate for forming a thin film pattern, is increased, so that a manufacturing expense is undesirably increased and manufacturing equipment used in the photolithography process becomes undesirably large.

In order to minimize the aforementioned problem, an inkjet printing method of forming a thin film pattern such as by dropping an ink, has been developed. The inkjet printing method is a method of forming a thin film by using an inkjet printing system. The inkjet printing system includes an inkjet head having an inkjet printing main body and a plurality of nozzles. The ink is dropped on a substrate through the nozzles of the inkjet head. The dropped ink is diffused based on a dropping position to generally form a uniform film thickness of the thin film pattern.

However, an ink drop dropped at a boundary of a printing area is undesirably diffused outside of the boundary of the printing area. With the ink diffusing outside of the boundary of the printing area, a profile and a thickness of the thin film formed by the inkjet printing method may not be uniform, and a shape of the desired boundary such as a straight line, may be uneven. Particularly, a desired film thickness and an external shape of the boundary portion of the printing area may be difficult to control.

Particularly, when the boundary of the area formed by the inkjet printing method is uneven and a margin of an alignment film area is not sufficient, the alignment film of a liquid crystal display may be in contact with a sealant for bonding and sealing the two display panels to each other, or on the contrary, the alignment film may not be applied on an area of the boundary of a display area for displaying an image. When the alignment film is in contact with the sealant, adhesive force of the sealant may deteriorate or moisture may be absorbed, so that reliability of the liquid crystal display may be degraded and resistance of an electrical short part of the two display panels may be increased. When the alignment film is not applied on the boundary portion of the display area, the alignment of liquid crystal is not controlled, so that a display defect may be generated in the liquid crystal display. Further, when a space for the margin of the alignment film area is increased in order to reduce or effectively prevent the aforementioned several problems, a space or planar distance between the display area and the sealant of the liquid crystal display is increased, so that a width of the boundary portion of the flat panel display device may be undesirably increased.

Hereinafter, exemplary embodiments of a display device according to the invention and a method of manufacturing the same will be described in detail with reference to the drawings.

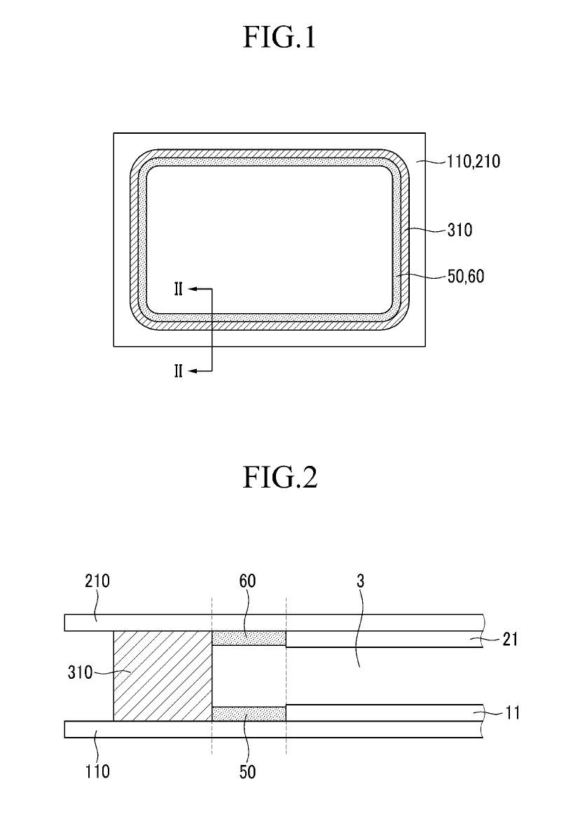

First, an exemplary embodiment of a display device according to the invention will be described with reference to FIGS. 1 to 4.

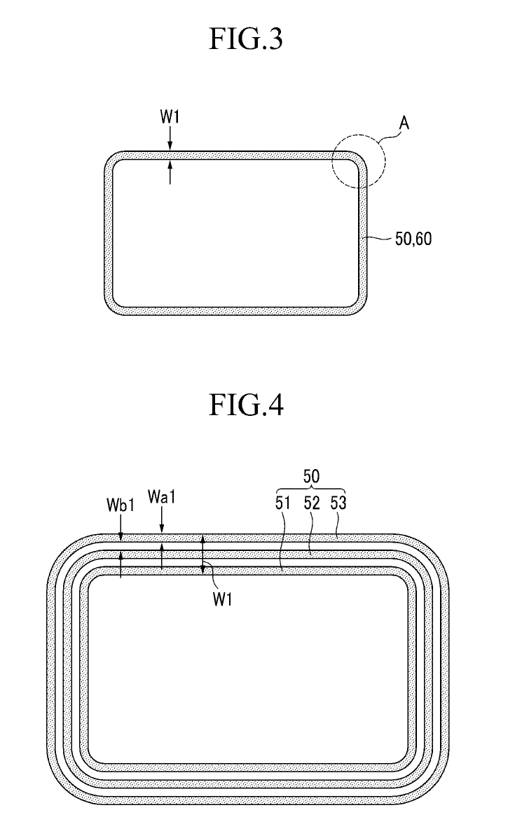

FIG. 1 is a top plan view of an exemplary embodiment a display device according to the invention, FIG. 2 is a cross-sectional view taken along line II-II of the display device of FIG. 1, and FIGS. 3 and 4 are top plan views of alternative exemplary embodiments of the display device according to the invention, respectively.

Referring to FIGS. 1 and 2, the exemplary embodiment of the display device according to the invention, which is a liquid crystal display, includes a lower substrate 110 and an upper substrate 210 facing each other, and a liquid crystal layer 3 interposed therebetween.

A sealant 310 is positioned between the lower substrate 110 and the upper substrate 210. The sealant 310 fixes the lower substrate 110 and the upper substrate 210 to each other by coupling the lower substrate 110 and the upper substrate 210, and confines the liquid crystal layer 3 between the lower and upper substrates 110 and 210. In the plan view, the sealant 310 is disposed along a circumference of the lower and/or upper substrates 110 and 210, such as near a boundary of the lower substrate 110 and the upper substrate 210. The sealant 310 may include a conductive ball (not illustrated) having conductivity, but is not limited thereto or thereby.

A lower alignment layer 11 and a lower outline frame 50 positioned in an internal area surrounded by the sealant 310 are positioned on the lower substrate 110. An upper alignment layer 21 and an upper outline frame 60 positioned in an internal area surrounded by the sealant 310 are positioned on the upper substrate 210. The lower alignment layer 11, the lower outline frame 50, the upper alignment layer 21 and/or the upper outline frame 60 may be a single, unitary, indivisible member, but is not limited thereto or thereby.

The lower alignment layer 11 and the upper alignment layer 21 are for determining an alignment of liquid crystals of the liquid crystal layer 3. Most of the lower and/or upper alignment layers 11 and 21 may be applied on the internal area surrounded by the sealant 310, but not being limited thereto or thereby.

In an exemplary embodiment of manufacturing the display device, the lower alignment layer 11 and/or the upper alignment layer 21 may be formed by an inkjet printing method, and the like. Where the lower alignment layer 11 and/or the upper alignment layer 21 are formed by the inkjet printing method, the lower alignment layer 11 and/or the upper alignment layer 21 may be formed by dropping an alignment solution on the lower substrate 110 or the upper substrate 210, respectively, from a nozzle of an inkjet head and drying the dropped alignment solution.

The alignment solution may include an alignment layer material, such as polyimide (“PI”), and a solvent. Viscosity of the alignment solution for the inkjet printing may be about 6 centipoise (cP) to about 10 cP. Surfaces of the lower substrate 110 and the upper substrate 210 on which the alignment solution is deposited, may be subjected to hydrophilic treatment in advance so that the alignment solution discharged on the lower substrate 110 and the upper substrate 210 spreads relatively easily when the inkjet printing for forming the lower alignment layer 11 and the upper alignment layer 21 is performed.

Most of the lower outline frame 50 is positioned between the lower alignment layer 11 and the sealant 310, and most of the upper outline frame 60 is positioned between the upper alignment layer 21 and the sealant 310. Among two opposing edges of the lower outline frame 50 and the upper outline frame 60, an edge closer to the alignment layers 11 and 12 is referred to as an inside edge, and an opposite edge thereof is referred to as an outside edge.

More specifically, the lower outline frame 50 defines and limits a boundary of the lower alignment layer 11, and the upper outline frame 60 defines and limits a boundary of the upper alignment layer 21. That is, the boundary of the lower alignment layer 11 does not run over or extend past the outside edge of the lower outline frame 50, so that a position or a shape of the boundary of the lower alignment layer 11 may be limited by the lower outline frame 50. The boundary of the upper alignment layer 21 also does not run over or extend past the outside edge of the upper outline frame 60, so that a position or a shape of the boundary of the upper alignment layer 21 may be limited by the upper outline frame 60.

The lower alignment layer 11 and the lower outline frame 50 may be positioned in and/or on a same layer of the display device, and the upper alignment layer 21 and the upper outline frame 60 may be positioned in and/or on a same layer of the display device.

The lower alignment layer 11 is in contact with a surface of the inside edge of the lower outline frame 50, but may not overlap the lower outline frame 50 such as in the plan view. However, as an alternative exemplary embodiment, the lower alignment layer 11 may overlap the lower outline frame 50, such as in the plan view.

Similarly, the upper alignment 21 is in contact with a surface of the inside edge of the upper outline frame 60, but may not overlap the upper outline frame 60 such as in the plan view. However, as an alternative exemplary embodiment, the upper alignment layer 21 may overlap the upper outline frame 60, such as in the plan view.

When the lower alignment layer 11 or the upper alignment layer 12 overlaps the lower outline frame 50 or the upper outline frame 60, respectively, the lower outline frame 50 or the upper outline frame 60 may be positioned under the lower alignment layer 11 or the upper alignment layer 21 at an overlapping portion. To be “under” the lower alignment layer 11 or the upper alignment layer 21 at an overlapping portion, in one exemplary embodiment, the lower outline frame 50 or the upper outline frame 60 may be positioned between the lower alignment layer 11 or the upper alignment layer 21, and the lower substrate 110 or the upper substrate 210, respectively, at the overlapping portion.

The lower outline frame 50 and the upper outline frame 60 are disposed along inside edges of the sealant 310 and form closed curved lines, respectively. The lower outline frame 50 and/or the upper outline frame 60 may be in contact with the sealant 310 as illustrated in FIG. 2. In an alternative exemplary embodiment, the lower outline frame 50 and/or the upper outline frame 60 may be spaced apart from the sealant 310 by a predetermined interval. According to another exemplary embodiment of the invention, the lower outline frame 50 and/or the upper outline frame 60 may partially overlap the sealant 310.

In an exemplary embodiment of manufacturing the display device, the lower outline frame 50 and the upper outline frame 60 are formed before the lower alignment layer 11 and the upper alignment layer 21. Further, the lower outline frame 50 and the upper outline frame 60 may include a material having lower surface energy, that is, a material having higher hydrophobicity, than that of the alignment solution of the lower alignment layer 11 and the upper alignment layer 21.

In one exemplary embodiment, for example, the lower outline frame 50 and/or the upper outline frame 60 may be formed by continuously positioning a liquid self assembly monolayer having hydrophobicity or a liquid (referred to as a “frame solution”) including a hydrophobic material, such as a fluoro resin and a hydrocarbon resin, and a solvent, on the lower and upper substrates 110 and 210, and then evaporating the solvent from the material of the lower outline frame 50 and/or the upper outline frame 60.

According to another exemplary embodiment of the invention, the lower outline frame 50 and/or the upper outline frame 60 may be formed by positioning the alignment solution for forming the lower and upper alignment layers 11 and 12 on the lower and upper substrates 110 and 210, respectively, and evaporating a solvent of the alignment solution. Where the solvent of the alignment solution is evaporated, the alignment layer material remaining after the solvent evaporates from the alignment solution has higher hydrophobicity than that of the alignment solution including the solvent, so that the lower outline frame 50 or the upper outline frame 60 formed as described above may have hydrophobicity relative to the alignment solution forming the alignment layer or a lower surface energy than that of the alignment solution forming the alignment layer.

The hydrophobicity of the lower outline frame 50 and the upper outline frame 60 may be hydrophobicity having a contact angle that is about 90 degrees or greater based on distilled water, but is not limited thereto.

As described above, according to one or more exemplary embodiment of the invention, when the lower alignment layer 11 and/or the upper alignment layer 21 are formed by the inkjet printing method, the alignment solution dropped on an area adjacent to the lower outline frame 50 and the upper outline frame 60 is not diffused over or further than the outside edge of the lower outline frame 50 and the upper outline frame 60, respectively. Accordingly, the dropped alignment solution may be substantially uniformly spread (e.g., the cross-sectional thickness) at the boundary of the dropping area, and the boundary (e.g., the planar outline) of the lower alignment layer 11 and/or the upper alignment layer 21 may have a uniform planar shape.

Further, according to one or more exemplary embodiment of the invention, the lower outline frame 50 and the upper outline frame 60 may be formed in a predetermined shape, and control of the position and/or the shape of the lower alignment layer 11 and the upper alignment layer 21 is improved, and the position and the shape of the boundary may be limited.

In exemplary embodiments, the lower outline frame 50 and/or the upper outline frame 60 may be formed by using various continuous jet printing methods, such as an aerosol jet method and an electro-hydro-dynamic (“EHD”) inkjet method, or by various deposition methods such as using a shadow mask.

When the continuous jet printing method is used, viscosity of the ink for the lower outline frame 50 and/or the upper outline frame 60, that is, the frame solution, may generally be greater than that of the alignment solution forming the lower and/or upper alignment layers 11 and 31. In one exemplary embodiment, for example, the viscosity of the frame solution may be about 5 cP to about 1,000 cP. Particularly, when the alignment solution is used as the frame solution, it is possible to increase viscosity of the frame solution by decreasing a proportion of the solvent in the alignment solution.

The boundaries of the lower outline frame 50 and the upper outline frame 60 formed by using the continuous jet printing method as described above may be substantially straight and continuous without having unevenness compared to the lower outline frame 50 and the upper outline frame 60 formed by using the inkjet printing method. Further, uniformity of the line widths of the lower outline frame 50 and the upper outline frame 60 may be increased.

When the lower outline frame 50 or the upper outline frame 60 is formed by using the continuous jet printing method, a pattern of a continuous line shape can be formed, so that the lower outline frame 50 and/or the upper outline frame 60 in a shape of a continuous straight line or a curved line may be formed. Further, when the lower outline frame 50 or the upper outline frame 60 is formed by using the continuous jet printing method, a rounded corner of the lower outline frame 50 and/or the upper outline frame 60 like in area “A” illustrated in FIG. 3, may also be formed.

The lower outline frame 50 and/or the upper outline frame 60 collectively includes portions extended in an extension direction. Referring to FIGS. 3 and 4, first portions of the lower outline frame 50 and/or the upper outline frame 60 are elongated in a first (e.g., left-to-right) direction, while second portions are elongated in a second (e.g., up-and-down) direction. The first and second directions may be inclined with respect to each other, such as being substantially perpendicular to each other, but not limited thereto or thereby. A width of the lower outline frame 50 and the upper outline frame 60 may be taken perpendicular to the extension (or elongation) direction.

Referring to FIGS. 3 and 4, in one exemplary embodiment, a width W1 of the lower outline frame 50 and/or the upper outline frame 60 according to the invention may be about 10 micrometers (μm) to about 100 μm, but is not limited thereto. Further, the corner of the lower outline frame 50 or the upper outline frame 60 may have a rounded shape as shown in the area “A” illustrated in FIG. 3.

The lower outline frame 50 and/or the upper outline frame 60 according to exemplary embodiment of the invention may be disposed in a single line or ring as illustrated in FIG. 3. Alternatively, the lower outline frame 50 and/or the upper outline frame 60 may be collectively formed by multiple lines or rings. As illustrated in FIG. 4, the lower outline frame 50 collectively includes rings 51, 52 and 53 spaced apart from each other. The rings 51, 52 and/or 53 may be a single, unitary indivisible member, but not limited thereto or thereby. When the lower outline frame 50 and/or the upper outline frame 60 includes the multiple lines 51 to 53, a width Wa1 of he lines 51, 52 and/or 53 may be smaller than about 10 μm. Further, a distance Wb1 between adjacent lines 51 and 52 and/or 52 and 53 may be several μm to several tens of μm, but is not limited thereto. The distance Wb1 may be freely adjusted within the range of an entire width W1 of the lower outline frame 50 and/or the upper outline frame 60 illustrated in FIG. 3 and FIG. 4. The distance Wb1 between the adjacent lines 51 and 52 and/or 52 and 53 may be uniform or non-uniform. The number of lines 51 to 53 included in one lower outline frame 50 and/or one upper outline frame 60 is not limited to the three illustrated in FIG. 4.

As illustrated in FIG. 4, when the lower outline frame 50 or the upper outline frame 60 collectively includes the multiple lines, an effect of limiting a spread area of the alignment solution at the boundary portion of the alignment layer area may be further increased when the lower alignment layer 11 and/or the upper alignment layer 21 is formed, and thus the width Wa1 of the respective multi lines 51 to 53 may be further decreased. Accordingly, the entire width W1 of the lower outline frame 50 or the upper outline frame 60 may be further decreased.

As described above, according to one or more exemplary embodiment of the invention, it is possible to limit the shape and/or the position of the boundary of the lower alignment layer 11 and the upper alignment layer 21, such that overlapping of the lower alignment layer 11 and/or the upper alignment layer 21 formed by the inkjet printing method, with the sealant 310, is reduced or effectively prevented. Accordingly, poor adherence of the sealant 310 that may occur due to the contact between the lower alignment layer 11 or the upper alignment layer 21 with the sealant 310, deterioration of reliability of a display panel of the display device due to moisture permeation to the internal area surrounded by the sealant 310, and/or an increase in resistance of an electrical short point between the lower substrate 110 and the upper substrate 210, is reduced or effectively prevented.

Further, non-uniformity of the boundary of the lower alignment layer 11 and/or the upper alignment layer 21 is reduced or effectively prevented, so that it is possible to decrease a planar space or interval between the area of the lower alignment layer 11 and/or the upper alignment layer 21, and the sealant 310, respectively, thereby further decreasing a width of a peripheral area of the display device as a result of the decreased interval.

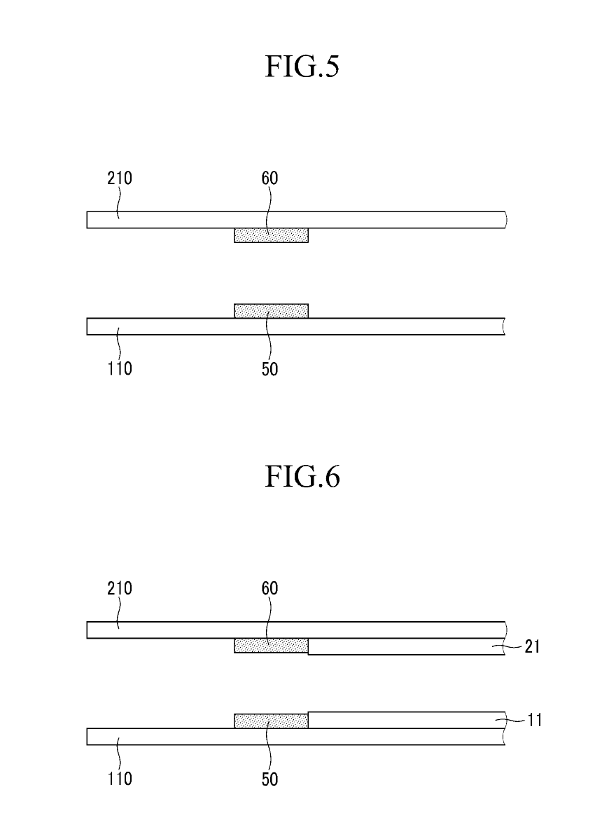

An exemplary embodiment of a method of manufacturing a display device according to the invention will be described with reference to FIGS. 5 and 6 together with the aforementioned drawings.

FIGS. 5 and 6 are cross-sectional views illustrating an exemplary embodiment of a method of manufacturing the display device according to the invention, respectively.

First, an electrical element (not shown) is formed (e.g., provided) by stacking various thin films on the lower substrate 110 and the upper substrate 210, respectively.

Next, the lower outline frame 50 and the upper outline frame 60 are formed on the lower substrate 110 and the upper substrate 210, respectively, such as by using various continuous jet printing methods including but not limited to, the aerosol jet method and the EHD inkjet method, or various deposition methods using a shadow mask, respectively. The lower outline frame 50 and/or the upper outline frame 60 may be formed along a boundary of an alignment layer area in which the lower alignment layer 11 or the upper alignment layer 21 is to be formed.

When the continuous jet printing method is used, viscosity of a frame solution for forming the lower outline frame 50 and/or the upper outline frame 60, may be generally greater than that of an alignment solution for forming the lower alignment layer 11 and/or the upper alignment layer 21. In one exemplary embodiment, for example, the viscosity of the frame solution may be about 5 cP to about 1,000 cP. A liquid self assembly monolayer material having hydrophobicity, a solution including a hydrophobic material such as a fluoro resin and a hydrocarbon resin, and/or an alignment solution having increased viscosity may be used as the frame solution.

Next, referring to FIG. 6, the lower alignment layer 11 and the upper alignment layer 21 are formed on the lower substrate 110 and the upper substrate 210, respectively, such as by dropping the alignment solution within an area of the respective substrate, the boundary of which is defined by the lower outline frame 50 and the upper outline frame 60. The alignment solution may be dropped by using the inkjet printing method, and the like. When the alignment solution is dropped by using the inkjet printing method, the dropped alignment solution may be spread well on the hydrophillically treated lower substrate 110 and/or upper substrate 210, but the area in which the dropped alignment solution is spread may be limited by the hydrophobic lower outline frame 50 and/or upper outline frame 60 disposed at the boundary of the alignment layer area, that is, an area adjacent to the lower outline frame 50 and/or the upper outline frame 60.

Further, the dropped alignment solution may be spread along the inside edge of the lower outline frame 50 and/or the upper outline frame 60. However, the dropped alignment solution may further spread onto the lower outline frame 50 and/or the upper outline frame 60 such as extending over the inside edge of the lower outline frame 50 and/or the upper outline frame 60. However, the alignment solution does not run over or extend beyond the outside edge of the lower outline frame 50 and/or the upper outline frame 60.

Next, the lower substrate 110 and the upper substrate 210 are combined with each other.

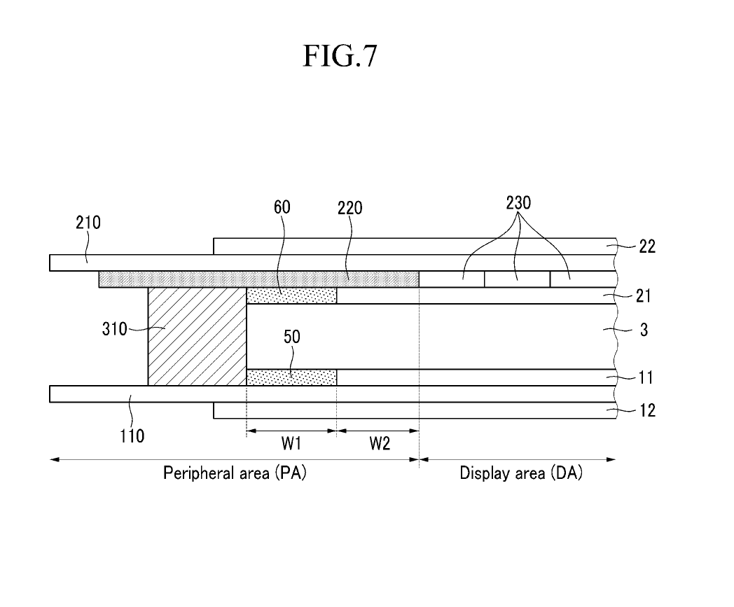

An exemplary embodiment of a display device according to the invention will be described with reference to FIG. 7 together with the aforementioned drawings. The same reference numerals are assigned to the same constituent elements as those of the aforementioned exemplary embodiment, and the same description will be omitted.

FIG. 7 is a cross-sectional view of an exemplary embodiment of a peripheral area of a display panel of a display device according to the invention.

The display device illustrated in FIG. 7 is substantially the same as the display device according to the aforementioned exemplary embodiment, so that the same description will be omitted.

The exemplary embodiment of the display device according to the invention, which is a liquid crystal display, includes the lower substrate 110 and the upper substrate 210 facing each other, and the liquid crystal layer 3 interposed therebetween. Further, polarizers 12 and 22 may be attached on an outside surface of the lower substrate 110 and the upper substrate 210, respectively. In an alternative exemplary embodiment, one or more of the polarizers 12 and 22 may be omitted.

In terms of a plane surface, the lower substrate 110 and the upper substrate 210 include a display area DA in which an image is displayed, and a peripheral area PA around the display area DA in which an image may not be displayed (e.g., a non-display area).

Although elements of the display area DA are not illustrated, the display area DA may include one or more signal line and one or more pixel connected to the signal line. A plurality of pixels may be arranged in an approximate matrix form.

The signal line may be disposed on the lower substrate 110 of a lower display substrate or a lower display panel of the display device. The signal line may include one or more gate line for transmitting a gate signal (also referred to as a “scan signal”) and one or more data line for transmitting a data voltage. An opposite electrode may be disposed on the upper substrate 210 of an upper display substrate or an upper display panel of the display device.

Each pixel of a plurality of pixels includes a switching element such as a thin film transistor connected to the signal line, a pixel electrode and the opposite electrode connected to each switching element and disposed on the lower substrate 110 and the upper substrate 210, respectively, and the liquid crystal layer 3 between the upper and lower substrates 110 and 210. The thin film transistor, and the like, may be disposed on the lower substrate 110 together with the pixel electrode, but is not limited thereto or thereby.

One or more color filter 230 may be positioned on an area of the display area DA facing the pixel. As used herein, a single color filter may be indicated by 230 or a plurality of color filters may be collectively referred to by 230. Each color filter 230 may display one primary color, such as one of three primary colors including red, green and blue. The color filter 230 may be positioned on the upper substrate 210 as illustrated in FIG. 7, but alternatively, may be positioned on the lower substrate 110.

The lower alignment layer 11 is positioned on substantially an entirety of the lower substrate 110 in the display area DA, and the upper alignment layer 21 is positioned on substantially an entirety of the upper substrate 210 in the display area DA.

The sealant 310 is positioned between the lower substrate 110 and the upper substrate 210, and fixes the two substrates 110 and 210 to each other by combining the two substrates 110 and 210. The sealant 310 is positioned in the peripheral area PA. The sealant 310 is disposed along a circumference or periphery of the display area DA.

A driving circuit (not shown), such as a gate driving unit and/or a data driving unit, may also be positioned in the peripheral area PA. More specifically, the driving circuit may be mounted such as directly mounted on the lower substrate 110 in the peripheral area PA in a form of an integrated circuit chip, may be mounted on a flexible printed circuit film to be attached to the lower substrate 110 in a form of a tape carrier package (“TCP”), or may be integrated on the lower substrate 110 together with the thin film transistor, and the like.

As illustrated in FIG. 7, a light blocking member 220 for blocking transmission of light may be positioned in the peripheral area PA. The light blocking member 220 may be positioned on the upper substrate 210 and/or the lower substrate 110.

The lower outline frame 50 is positioned on the lower substrate 110 in the peripheral area PA, and the upper outline frame 60 is positioned on the upper substrate 210 in the peripheral area PA. The entire width W1 of the lower outline frame 50 or the upper outline frame 60 may be about 10 μm to about 100 μm, but is not limited thereto. Further, a margin of a boundary of the lower outline frame 50 and/or the upper outline frame 60 may be equal to or smaller than about 10 μm.

The lower alignment layer 11 and/or the upper alignment layer 21 in the display area DA may be further extended from the display area DA and disposed on the lower substrate 110 and the upper substrate 210 between the lower outline frame 50 or the upper outline frame 60 in the peripheral area PA, respectively, and the display area DA. A width W2 of an extended area of the lower alignment layer 11 and/or the upper alignment layer 21 between the lower outline frame 50 and the upper outline frame 60, and the display area DA, respectively, may be equal to or smaller than about 100 μm. A margin of a boundary of the extended area having the width W2 may be equal to or smaller than about 10 μm.

As described above, according to one or more exemplary embodiment of the invention, since the position and the shape of the boundary of the lower alignment layer 11 and/or the upper alignment layer 21 are limited by the lower outline frame 50 and the upper outline frame 60, respectively, non-uniformity of the boundary may be reduced or effectively prevented, so that an area for the margin of the lower alignment layer 11 and/or the upper alignment layer 21 disposed in the peripheral area PA, that is, an area between the sealant 310 and the display area DA may be decreased. More specifically, the width between the display area DA and the sealant 310 may be decreased to be equal to or lower than about 200 μm. Accordingly, the width of the peripheral area of the display panel of the display device may be further decreased, so that configurations of the display device such as a tiled display panel may be achieved.

In the aforementioned exemplary embodiments, the alignment layers 11 and 21 are applied to both the lower substrate 110 and the upper substrate 210 in the liquid crystal display, but the invention is not limited thereto. Alternatively, the alignment layers 11 and 21 and the outline frames 50 and 60 may be applied only on only one of the substrates 110 and 210. Where the alignment layers 11 and 21 and the outline frames 50 and 60 may be applied only on only one of the substrates 110 and 210, the outline frames 50 and 60 may be disposed only on the substrates 110 and 210 on which the alignment layers 11 and 21 are respectively applied.

Further, in the aforementioned several exemplary embodiments, the alignment layer of the liquid crystal display is formed by the inkjet printing method, but the invention is not limited thereto. Alternatively, various thin films may be formed on the substrate by any of a number of dropping methods of which the inkjet printing method is only an example. That is, in the forming of a thin film by the dropping method, the outline frame for defining the boundary of the area in which the thin film is to be formed is firstly formed, and then the thin film is formed by dropping material (e.g., an ink) for the thin film inside the outline frame, thereby reducing or effectively removing non-uniformity of the desired shape and the position of the outer boundary of the thin film. In the above-described embodiment, a material forming the outline frame may have a lower surface energy or stronger hydrophobicity than that of the ink material of the thin film.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of manufacturing a display device, comprising:
providing an outline frame comprising a frame material, on a first substrate; and
providing a thin film by dropping a thin film material inside a boundary defined by the outline frame,
wherein
the outline frame limits a boundary of the thin film, and
the frame material of the outline frame has a surface energy less than a surface energy of the thin film material of the thin film.

2. The method of claim 1, wherein:
the providing the outline frame comprises continuously dropping the frame material on the first substrate using a continuous jet printing method.

3. The method of claim 2, wherein:
the outline frame comprises multiple lines spaced apart from each other.

4. The method of claim 1, wherein:
the frame material of the outline frame comprises a hydrophobic material.

5. The method of claim 1, wherein:
the outline frame comprises a closed curved line.

6. The method of claim 1, wherein:
the thin film comprises an alignment layer,
the alignment layer comprises an alignment solution.

7. The method of claim 6, wherein:
the frame material of the outline frame comprises the alignment solution.

8. The method of claim 7, wherein:
a viscosity of the alignment solution of the outline frame is higher than a viscosity of the alignment solution of the alignment layer.

9. The method of claim 1, further comprising:
preparing a second substrate, and disposing the second substrate facing the first substrate; and
providing a sealant between the first substrate and the second substrate,
wherein
the first substrate and the second substrate comprises a display area in which an image is displayed, and a peripheral area around the display area, and
the outline frame is between the sealant and the display area.

10. The method of claim 9, wherein:
a width of the outline frame is about 10 micrometers to about 100 micrometers.

11. The method of claim 10, wherein:
a distance between the outline frame and the display area is equal to or smaller than about 100 micrometers.

12. A display device formed by the method of claim 1, comprising:
the first substrate; and
the thin film on the first substrate,
wherein
the thin film is provided by dropping the thin film material on the first substrate using an inkjet printing method; and
the outline frame is provided before the thin film is provided, along a boundary of an area of the first substrate in which the thin film is to be provided.

13. The display device of claim 12, wherein:
a boundary of the outline frame is substantially even and continuous.

14. The display device of claim 13, wherein:
the outline frame comprises multiple lines spaced apart from each other.

15. The display device of claim 12, wherein:
the outline frame comprises a closed curved line.

16. The display device of claim 12, wherein:
the thin film comprises an alignment layer, the alignment layer comprises an alignment solution.

17. The display device of claim 16, wherein:
the alignment solution comprises an alignment layer material; and
the frame material of the outline frame comprises the alignment layer material of the alignment solution.

18. The display device of claim 12, further comprising:
a second substrate facing the first substrate; and
a sealant between the first substrate and the second substrate,
wherein
the first substrate and the second substrate comprises a display area in which an image is displayed, and a peripheral area around the display area, and
the outline frame is between the sealant and the display area.

19. The display device of claim 18, wherein:
a width of the outline frame is about 10 micrometers to about 100 micrometers.

20. The display device of claim 19, wherein:
a distance between the outline frame and the display area is equal to or smaller than about 100 micrometers.
